(19) United States
(12) Patent Application Publication
(10) Pub. No.: US 2009/0159825 A1
(43) Pub. Date: Jun. 25, 2009

(54) Fluid Coupling with a Valve Arrangement

(75) Inventors: Jens Trimborn, Wuppertal (DE); Thomas Koch, Northeim (DE)

Correspondence Address: COLLARD & ROE, P.C., 1077 NORTHERN BOULEVARD, ROSLYN, NY, 11576, US

(73) Assignee: Frotek Kunststofftechnik GmbH

(21) Appl. No.: 11/992,246

(22) PCT Filed: Sep. 21, 2006
(86) PCT No.: PCT/EP2006/066570

§ 371 Date: Mar. 19, 2008

(30) Foreign Application Priority Data
Sep. 21, 2005 (DE) 102005045154.3

(51) Int. Cl. F16L 37/28

(52) U.S. Cl. 251/149.1

(57) ABSTRACT

The invention relates to a fluid coupling with a bush (100) and a plug (200), which respectively contain a moveably mounted valve body (102, 202). The valve bodies have closing heads (108, 208) which are positioned at the side of a fluid channel and, in the separated state of plug and bush, close associated outlet openings. When plug (200) and bush (100) are plugged together, the valve bodies are transferred by contact with the respective other housing into an open position, in which they are removed from the fluid flow.

The invention relates to a fluid coupling with a bush and a plug as well as a valve arrangement which closes the outlets of bush and plug in the separated state.

Fluid couplings of the kind mentioned at the outset are known for example from EP 670 023 B1. They consist of a fluid coupling bush (hereinafter simplified referred to as “bush”) as well as a fluid coupling plug (hereinafter simplified referred to as “plug”), each of which in the interior comprises a valve body which is mounted in a displaceably moveable manner. The valve bodies are preloaded through springs in a closing position in which they seal the fluid outlet of plug and bush with a closing head. When bush and plug are joined the closing heads come in contact with each other and respectively displace each other from their respective closing position into an opening position. In the plugged-together state of plug and bush a continuous connection for the fluid flow is thus obtained. With the known arrangement the closing heads of the valve bodies are situated in the middle of the fluid flow and thus constitute an obstacle to said fluid flow.

Furthermore, a fluid coupling is known from EP 681 137 A2 with which under water a connection between two oil lines can be established. The fluid coupling comprises a plug element with a tubular fluid channel whose lateral fluid outlet in the state not plugged together is closed by a ring-shaped valve body. Before this background it was the object of the present invention to provide a fluid coupling which is improved in terms of fluid engineering.

This object is solved through a fluid coupling element according to Claim 1 and through a fluid coupling according to Claim 2. Advantageous embodiments are contained in the subclaims.

According to its first aspect the invention relates to a fluid coupling element with a valve arrangement, wherein the expression “element” constitutes a general term for the bush and the plug of a fluid coupling. In addition the term “fluid” in the following should generally stand for media capable of flowing, i.e. as usual more preferably comprise liquids (e.g. water) and gases (e.g. air). The fluid coupling element contains the following two essential components:
a) A housing with at least one fluid inlet and at least one fluid outlet which are joined through a fluid channel. The fluid inlet can for example be designed as sleeve-shaped socket for fitting a flexible hose. The fluid outlet preferentially has a circular, oval or polygonal cross-sectional opening. In addition the fluid outlet according to the definition is to be situated at the transition to a complementary fluid coupling element. The terms “inlet” and “outlet” arbitrarily allocated here thus correspond to a flow direction of the fluid which from the fluid coupling element under consideration leads to a complementary fluid coupling element; obviously in the state as used the flow can also be in the opposite direction, i.e. enter through the “fluid outlet” and exit through the “fluid inlet”.
b) A valve body moveably mounted in the aforementioned housing with at least one closing head, which in a preloaded closing position closes the fluid outlet and opens it in an opening position. If the housing has several fluid outlets the valve body has a corresponding number of associated closing heads. The preload of the valve body can for example be generated by a spring and results in that the closing head closes the fluid outlet without the effect of external forces.

The fluid coupling element is characterized in that the mentioned closing head, when it assumes the opening position, is substantially situated outside the fluid flow (more exactly outside the space through which a fluid is able to flow).

Other than with fluid couplings according to EP 670 023 B1 the closing head with the fluid coupling element described above is not circulated by fluid but the fluid flow entirely passes by the closing head. The fluid flow thus faces substantially less resistance. The fluid coupling element can thus be designed in such a manner that altogether a substantially laminar flow passes through it.

The invention further relates to a fluid coupling with a valve arrangement containing a bush and a plug fitting said bush. The bush and the plug can be embodied more preferably in the manner of the fluid coupling element described above and contain the following components each:
a) A housing with at least one fluid inlet and at least one fluid outlet which are connected by a fluid channel. The housing otherwise corresponds to the one described above for the fluid coupling element under a).
b) A valve body moveably mounted in the housing mentioned above with at least one closing head which in a preloaded closing position closes the fluid outlet and opens it in an opening position. The valve body otherwise corresponds to the one described above for the fluid coupling element under b).

The fluid coupling is characterized in that
(i) when being plugged together the valve body of the bush through contact with the housing of the plug is moved from the closing position to the opening position and/or
(ii) that the valve body of the plug through contact with the housing of the bush is moved from the closing position to the opening position.

The movement of the valve body through the housing of the other fluid coupling element has the advantage that the valve body is displaced by the entire plugging distance. In fluid couplings according to EP 670 023 B1 wherein the valve bodies of the fluid coupling elements support each other, the plugging distance in contrast is divided over both valve bodies so that in each case only half as great a displacement of the closing heads is possible.

Preferred embodiments of the invention are explained in the following, which can relate to both a fluid coupling element as well as a fluid coupling with two complementary fluid coupling elements (bush or plug) of the type explained above.

According to a first embodiment the valve body can contain two (preferentially substantially arranged symmetrically) closing heads between which the fluid channel is arranged.

Obviously the corresponding housing must also be designed according to the valve body, i.e. the housing must comprise two spaced fluid outlets. Preferentially both the valve body as well as the corresponding housing are designed substantially symmetrically. This has the advantage that forces or effects acting across the symmetry axis cancel each other out. As a result, the valve body with a fluid flow in direction of the symmetry axis can be moved free of transverse forces.

According to another preferred embodiment the plug comprises two parallel outlet channels which can be inserted in a sealing manner in corresponding plug-in openings of the bush. Advantageously the outlet channels in this case are cylindrical or oval so that they can be sealed by a simple 0-ring against the plug-in openings.

The outlet channels mentioned above preferentially have a shoulder at each of their front ends which on plugging together of the fluid coupling comes in contact with the closing head of the bush. The closing head of the bush is then forced back in the opening position through the shoulder of the outlet channels of the plug.

According to another further development of the invention the valve body of at least one fluid coupling element comprises an actuation pin which is led from the housing interior to the outside in a sealed manner, which actuation pin on plugging together of the fluid coupling is in contact with the housing of the other fluid coupling element. Via the actuation pin the valve body can thus be forced back from the closing position to the opening position.

Preferentially the actuation pin mentioned above is arranged along a symmetry axis of the valve body. In this manner it is achieved that the forces exerted via the actuation pin act in the direction of the symmetry axis and transverse forces which could result in canting are avoided.

Another advantageous development of the valve body provides that it comprises at least one guide sleeve which is mounted displaceably moveable against a spring force on a guide pin of the corresponding housing. Secure mounting with good mobility at the same time can be realized in this manner. The closing head can more preferably be circular in cross section. However it can also be oval (ellipsoid) or polygonal in cross section as a result of which particularly flat shapes of the fluid coupling can for instance be achieved.

In the following the invention is exemplarily explained with the help of the Figures. It shows:

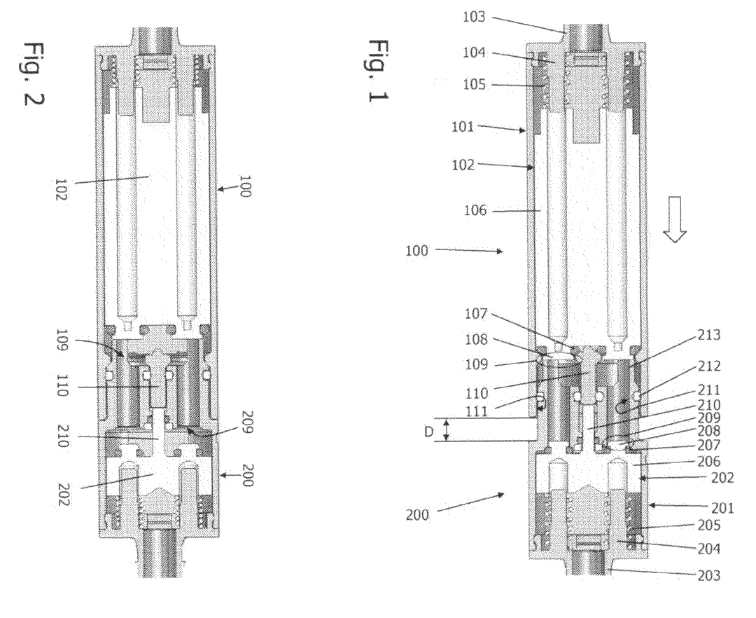

FIG. 1 a section through a fluid coupling according to the invention with a bush 100 and a plug 200 at the start of the plugging operation;

FIG. 2 the fluid coupling of FIG. 2 in the completely plugged-together state;

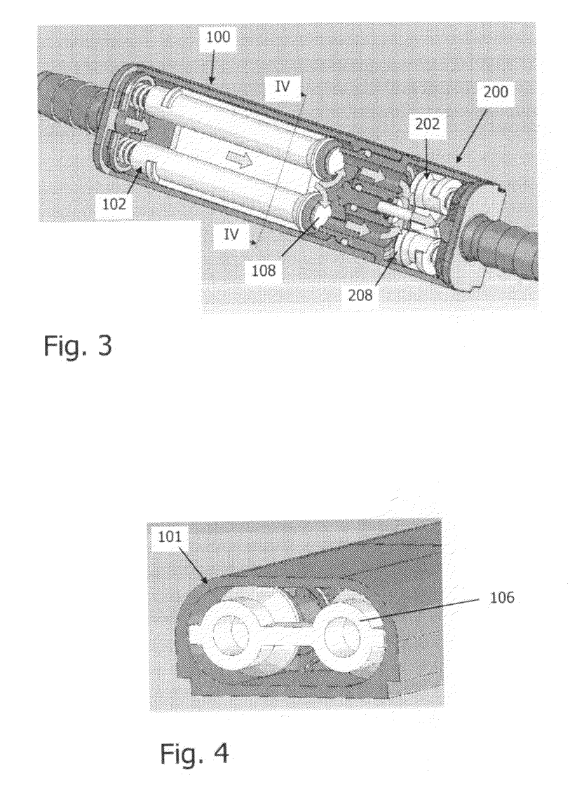

FIG. 3 a perspective view of the fluid coupling from FIG. 2 with partially removed or transparent cover of the housing and a indicated flow from the bush to the plug;

FIG. 4 a section along the line IV-IV from FIG. 3.

The invention is explained in the following by means of a special embodiment of a fluid coupling, wherein all figures show the same embodiment and identical reference symbols therefore belong to identical components. The fluid coupling can more preferably correspond to the standard DIN 43589-1 for plug devices. It can for example serve to supply accumulator batteries with fresh water and/or to provide air circulation or central degassing for this purpose.

FIG. 1 shows the fluid coupling at the start of the plugging operation. The coupling consists of a bush 100 and a plug 200 fitting said bush.

The bush 100 comprises a housing 101 with a valve body 102 moveably mounted therein. The housing 101 on one side has a fluid inlet 103 formed as plug socket for the connection of a hose (only partially shown). On the side facing the plug 200 the housing 101 has two parallel cylindrical plug-in openings 111 each of which starts at fluid outlets 109. These fluid outlets 109 in the state shown are each closed by a closing head 108 of the vale body 102, wherein each of the closing heads 108 are surrounded by a ring-shaped seal 107. Instead of being circular as shown, the closing heads 108 can also be oval for example in order to achieve a preferably flat design of the fluid coupling to suit the standard. In addition, the closing heads 108 are continued in axial direction through guide sleeves 106, wherein the mentioned guide sleeves are fitted onto guide pins 104 of the housing 101. The valve body 102 is pushed into the closing position by springs 105 surrounding the pins 104. The guide sleeves 106 are furthermore connected with one another via a flat land so that the valve body 102 altogether is of a symmetrical construction. Along the flat land, a laminar flow of the medium can occur in an advantageous manner.

The plug 200 substantially has a similar construction, wherein the reference symbols of corresponding components are increased by 100 relative to those of the bush. The plug 200 more preferably comprises a housing 201 with a fluid inlet 203 (only partially shown). Towards the bush the housing 201 has two parallel cylindrical outlet channels 211 which on the outside are surrounded by circular seals 212 mounted in slots and which can be inserted in a sealing manner in the plug-in openings 111 of the bush 100. At the end facing away from the bush the outlet channels 211 each have a circular outlet opening 209 which in the state shown are closed in a sealing manner by the closing head 208 of a moveably mounted valve body 202. The closing head 208 is surrounded by a ring seal 207. In addition, the two closing heads 208 of the valve body 202 are continued in the manner explained above by two parallel cylindrical guide sleeves 206 which are mounted on guide pins 204 against springs 205. The valve body 202 furthermore comprises an actuation pin 210 in continuation of its axis of symmetry pointing towards the bush 100, which between the two outlet channels 211 is led to the outside in a sealing manner from the housing 201 of the plug. At the start of the plugging operation shown in FIG. 1 the actuation pin 210 happens to be in contact with a stop 110 formed on the bush housing 101.

With regard to the closing heads 108, 208 and the corresponding seals 107, 207 it must be pointed out that in the closing position the pressure of the medium present on the inside substantially acts in the closing direction, i.e. supports the preload of the respective springs 105 and 205.

The bush 100 and the plug 200 can be plugged together in the direction of the arrow from FIG. 1 by the plugging distance D. FIG. 2 shows the fluid coupling after completion of this plugging operation in the completely plugged-together state. Here, the valve body 102 of the bush 100 has been displaced from the closing position into a pulled-back opening position through the contact with the shoulders 213 of the plug housing. In a similar manner the valve body 202 of the plug 200 has been transferred from the closing position into the opening position through the contact of the actuation pin 210 with the stop 110 of the bush housing. The fluid outlets 109, 209 of bush and plug respectively are thus open and a fluid such as water is able to flow through the fluid coupling. As indicated in FIG. 3 by arrows the flow path can for example lead from the fluid inlet 103 of the bush 100 via the fluid channel running centrally along the axis of the housing through the fluid outlets 109, through the outlet channels 211 and through the fluid outlets 209 into a central fluid channel of the plug 200 and from there to the fluid inlet 203 of the plug 200. Obviously the flow of the fluid can also take place in opposite direction. Advantageously the closing heads 108, 208 each are situated completely outside the flow.

1. A fluid coupling element (100, 200) with valve arrangement containing
a) a housing (101, 201) with at least one fluid inlet (103, 203) and at least one fluid outlet (109, 209) which are connected by a fluid channel,
b) a valve body (102, 202) moveably mounted in the housing (101, 201) with at least one closing head (108, 208) which in a preloaded closing position closes the fluid outlet (109, 209) and in an opening position opens said fluid outlet,
wherein the closing head (108, 208) in the opening position is substantially situated outside the fluid flow.

2. A fluid coupling with valve arrangement containing a fluid coupling bush (100) and a fluid coupling plug (200) fitting said fluid coupling bush each with
a) a housing (101, 201) with at least one fluid inlet (103, 203) and at least one fluid outlet (109, 209) which are connected by a fluid channel,
b) a valve body (102, 202) moveably mounted in the housing (101, 201) with at least one closing head (108, 208) which in a preloaded closing position closes the fluid outlet (109, 209) and in an opening position opens said fluid outlet,
wherein on plugging together the fluid coupling
the valve body (102) of the fluid coupling bush (100) through contact with the housing (201) of the fluid coupling plug (200)
and/or
the valve body (202) of the fluid coupling plug (200) through contact with the housing (101) of the fluid coupling bush (100) is moved from the closing position in the opening position.

3. The fluid coupling according to claim 2, wherein it contains a fluid coupling bush (100) and/or a fluid coupling plug (200) according to claim 1.

4. The fluid coupling element or fluid coupling according to claim 1, wherein the valve body (102, 202) contains two closing heads (108, 208) between which the fluid channel is arranged and which are preferentially arranged substantially symmetrically.

5. The fluid coupling according to claim 1, wherein the fluid coupling plug (200) comprises two parallel outlet channels (211) which can be inserted in a sealing manner in corresponding plug-in openings (111) of the fluid coupling bush (100).

6. The fluid coupling according to claim 5, wherein the outlet channels (211) at the front end comprise a shoulder (213) which on plugging together of the fluid coupling comes in contact with the closing head (108) of the fluid coupling bush (100).

7. The coupling element or fluid coupling according to claim 1, wherein the valve body (202) comprises an actuation pin (210) led to the outside from the housing interior in a sealing manner, which on plugging together of the fluid coupling is in contact with the housing of the other fluid coupling element.

8. The fluid coupling element or fluid coupling according to claim 7, wherein the actuation pin (209) is oriented along a symmetry axis of the valve body (202).

9. The fluid coupling element or fluid coupling according to claim 1, wherein the valve body (102, 202) comprises at least one guide sleeve (106, 206) which is mounted on a guide pin (104, 204) of the housing (101, 201) in a moveably displaceable manner against a spring force.

10. The fluid coupling element or fluid coupling according to claim 1, wherein the closing head (108, 208) is circular, oval or polygonal.
